(19) United States
(12) Patent Application Publication
(10) Pub. No.: US 2012/0203579 A1
(43) Pub. Date: Aug. 9, 2012

(54) SYSTEM FOR BOOKING A TIME PERIOD FOR UTILISING A TIME BASED SERVICE OR RESOURCE

(75) Inventors: Roger Glasson, Cleveland (AU); Philip Miller, Cleveland (AU)

(73) Assignee: GObookings Systems Pty Ltd, Cleveland (AU)

(21) Appl. No.: 13/287,411

(22) Filed: Nov. 2, 2011

Related U.S. Application Data
(60) Provisional application No. 61/506,812, filed on Jul. 12, 2011.

(30) Foreign Application Priority Data
Feb. 7, 2011 (AU) 2011100160

(51) Int. Cl. G06Q 10/02

(52) U.S. Cl. 705/5

(57) ABSTRACT

A system for booking a time period includes at least one provider arrangement on which a resource/service provider can indicate one or more available time periods within which they are able to provide a resource or service, and a plurality of user portals. Each user portal indicates which time periods of the service or resource provider/s are available to be booked on that portal by a user and facilitates booking of an available time period by a user. A synchronization and communications arrangement facilitates direct communication between the provider arrangement and each user portal in real time over a communication network to communicate the booking of an available time period on a the portal by a user to the provider arrangement and the other portals. This updates the available time periods on the provider arrangement and the user portals and removes each booked time period from the available time periods.

### CROSS-REFERENCE TO RELATED APPLICATIONS

This application claims priority from U.S. Provisional Patent Application No. 61/506,812 titled “A System For Booking A Time Period For Utilizing A Time Based Service or Resource” filed on Jul. 12, 2011 and incorporated fully herein by reference.

### FIELD OF THE INVENTION

The invention relates to a system for booking a time period for utilising a time based service or resource provided by a resource/service provider. The invention also relates to a method for booking a time period for utilisation of a time based resource or service over a communication network. The invention also extends to a computer software code for integrating a provider of an online hosted booking system and a software program implementing the software code for booking a time based service or resource.

The invention has particular but not exclusive application to a system for booking an appointment on the world wide web with a service provider such as an accountant, a lawyer, or a medical service provider from a selection of available appointment times for that service. The invention also has particular application to a system for booking a time period on the world wide web for utilising a resource such as a meeting room, a sports facility, or a piece of equipment from a selection of available appointment times for that resource. However at the same time it is to be clearly understood that the invention is capable of broader application.

### DEFINITIONS

In this specification the term ‘time period’ shall be understood to mean an amount of time that is allocated or set aside for a time based activity such as an appointment or a use of a resource. The time period may conveniently be referred to as a time slot and may be a half hour time slot or a longer or shorter period of time. For example where the time based activity is a professional consultation then the period of time may for example be half an hour or one hour. However the term ‘time period’ is to be interpreted broadly and includes time periods of any duration.

### BACKGROUND TO THE INVENTION

A booking system is a system for booking time slots for the provision of a resource or service. Applicant believes that a large number of businesses, and in particular in the service industry, that sell an inventory of time-slots (e.g. professional services such as law and medicine, restaurants, golf courses, and spas.) still use manual booking systems using a “pencil and paper” to make reservations/appointments and manage these reservations/appointments. Only in recent times have providers of time based resources and services embraced the internet and the possibilities provided by online systems. This is in sharp contrast to retail services or online shopping, which has been provided over the internet for some time.

An internet scheduling booking system is a system for booking time slots for the provision of a resource or service that can be accessed over the internet. Currently providers of Internet based scheduling booking systems aggregate information from their service resource providers and display this aggregated information on a single Internet based directory or portal. These Internet based online business directories or portal type web sites (portals) and Internet based online scheduling booking systems (systems) are limited to a one-to-one relationship between the scheduling booking system and the internet based directory or portal. Thus available time slots can only be communicated to one portal and the current technology only allows for the business owner to integrate with one specific portal. Often this portal is supplied by the provider of the online scheduling booking system.

The limitation that available time slots can only be published on only one portal limits the audience that can be reached by the business owner. Naturally this limits the reach of the technology and consequently its ability of the owner to attract custom in the form of bookings from a wider field.

Clearly it would be advantageous if a system or process could be devised that helped to at least ameliorate some of the limitations of current scheduling booking systems for booking time slots for the provision of resources or services. In particular, it would be advantageous if ways could be found to exploit the potential to be offered by an online world.

### SUMMARY OF THE INVENTION

According to one aspect of this invention there is provided a system for booking a time period for utilising a time based resource or service provided by a resource/service provider, including at least one provider arrangement on which a resource/service provider can indicate one or more available time periods within which they are able to provide a resource or service to a user.

A plurality of user directories or portals, each of which indicates the one or more available time periods of the service or resource provider/s that are available to be booked on that directory or portal by a user, and which facilitates booking of one or more of the available time periods by a user on a said directory or portal through the directory or portal, Is provided. A synchronization and communications arrangement which facilitates direct communication between the provider arrangement and each user directory or portal over a communication network, whereby to communicate the booking of an available time period on a said directory or portal by a user to the provider arrangement and the other directories or portals, whereby to update the available time periods on the provider arrangement and the user directories or portals and to remove each time period that has been booked from the available time periods is also provided.

Each provider arrangement may be a scheduling booking system, e.g. an online scheduling booking system and in particular a hosted online scheduling booking system.

The system may include a plurality of provider arrangements, each of which provides a different provider with access to the booking system. Each provider arrangement may enable a resource/service provider to select which time periods are available to be booked on each of the user directories or portals, and the synchronization and communications arrangement may communicate the time periods that are available to be booked on each directory or portal to that directory or portal and not to the other directories or portals.

The provider arrangement may enable a provider to make an independent selection of time periods that are available to be booked on each user directory or portal. Thus the provider arrangement can enable a provider to make a selection of available time periods on any user directory or portal that is different from the selection of available time periods on other user directories or portals. Thus a provider can make a different selection of time periods available to be booked on different user directories or portals.

The synchronization and communications arrangement may enable the provider arrangement/s to communicate directly with each user directory or portal on which time periods are available to be booked whereby to update the available time periods on the provider arrangement/s and each of the directories or portals in real time.

The synchronization and communications arrangement may facilitate direct communication between the provider arrangement and each user directory or portal in real time whereby to synchronise the available time periods on the provider arrangement and all the directories or portals.

Each provider arrangement may enable the associated provider to alter any one of the time periods that are available to be booked on said plurality of user directories and portals. Further the synchronization and communications arrangement may facilitate direct and continuous communication between the provider arrangement and each user directory or portal whereby to update the available time periods on the relevant user directories and portals to reflect these alterations.

The service/resource provider may communicate an intention to cancel certain time periods that they have previously indicated as being available, and the synchronization and communications system may then cause these time periods to be removed from the portal or directory to reflect the cancellations.

The time period for utilising a time based resource or a time based service may be an appointment with a service provider that is a specific length of time. In particular it may be an appointment for a half an hour or an hour. Instead the time period for utilising a time based resource may be an opportunity to utilise a resource such as a meeting room or a sports facility for a specific length of time.

The synchronization and communications arrangement may, in response to a booking of an available time period being made, send a message to the resource/service provider, for whom the booking has been made to notify them of the booking, including the time period for which the booking has been made. The synchronization and communications arrangement may also notify the resource/service provider of the portal, which made the booking.

The synchronization and communications arrangement may send a message to the resource/service provider in the form of an SMS message or an email message, and the message optionally may be sent to the resource/service provider's mobile communication device.

The synchronization and communications arrangement may forward a user a confirmation of the booking of an available time period to a user. For example the confirmation of the booking may be sent to the user as an email or as an SMS message and the message optionally may be sent to the user's mobile communication device.

Further, the synchronization and communications arrangement may also forward a user a reminder in relation to the booking of an available time period, e.g. in the form of an SMS or email message. Further the reminder may be sent at a predetermined time period before the appointment commences.

Each directory or portal may have a user interface that enables members of the public including potential users, to access and view the available time periods of the service/resource provider and book an available time period with a service/resource provider.

Similarly each provider arrangement, e.g. that is an online scheduling booking system, may include a provider interface that enables a provider to access and view their time periods on each portal or directory that are available to be booked and their time periods on each portal or directory that are available to be booked.

The synchronization and communications arrangement may operate over a communications network that is the world wide web.

According to another aspect of this invention there is provided a system for booking a time period for utilising a time based resource or service provided by a resource/service provider, including a plurality of provider arrangements on each of which a resource/service provider can indicate one or more available time periods within which they are able to provide a resource or service to a user. At least one user directory or portal is provided which indicates the available time periods of each of the resource/service providers that are available to be booked on the directory or portal by a user, and which facilitates booking of the available time periods by a user on the directory or portal through the directory or portal. A synchronization and communications arrangement is provided which facilitates direct communication between each provider arrangement and the user directory or portal over a communication network, whereby to communicate the booking of an available time period on the directory or portal by a user to the provider arrangement associated with that resource/service provider, and to update the available time periods on the associated provider arrangement and the user directory or portal.

The system may have a single user directory or portal. In this form a single user directory or portal interacts with a plurality of different provider arrangements corresponding to different providers.

Each provider arrangement may be a scheduling booking system, e.g. an online scheduling booking system. Each provider arrangement may enable its associated provider to make their own selection of their time periods that are available to be booked, and the synchronization and communications arrangement may communicate said available time periods to the directory or portal.

The synchronization and communications arrangement may facilitate direct communication between each provider arrangement and the user directory or portal in real time whereby to synchronise the time periods that are available to be booked for each provider on the directory or portal and also on the provider arrangements of each provider.

Each provider arrangement may enable the associated resource/service provider to alter any one of the time periods that are available to be booked on said user directory or portal. Further the synchronization and communications arrangement may facilitate direct communication between each provider arrangement and the user directory or portal whereby to update the available time periods on the user directory or portal to reflect these alterations.

The service/resource provider may communicate an intention to cancel certain time periods that have previously been indicated as being available time periods, and the synchronization and communications system may then cause these time periods to be removed from the portal or directory so that they are no longer indicated as being available.

The time period for utilising a time based resource or service timer period may be an appointment with a service provider that is a specific length of time. In particular it may be an appointment for a certain length of time such as half an hour or an hour. Instead the time period for utilising a time based resource or service time period may be an opportunity to utilise a resource such as a meeting room.

The synchronization and communications arrangement may further send a message to the resource/service provider whose time period has been booked to advise that the time period has been selected, e.g. in the form of an SMS message or an email message that is sent to a mobile communication device of the resource provider.

The synchronization and communications arrangement may forward a user a confirmation of a booking of a time period to a user. The confirmation of a booking of a time period may be sent to the user as an email and/or as an SMS message that is sent to a mobile communication device of the user.

The synchronization and communications arrangement may forward a user a reminder in relation to said booking of a time period, e.g. in the form of an email and/or as an SMS message.

According to another aspect of this invention there is provided a method for booking a time period for utilisation of a time based resource or service provided by a service/resource provider over a communications network, the method including indicating time periods for provision of resources or services by a resource/services provider that are available to be booked on a provider arrangement and facilitating access to at least one user directory or portal on which the available time periods are ascertainable to a user. Also included in the method is booking an available time slot on the user directory or portal and communicating the booking to the provider arrangement, whereby to communicate each booking appointment of an available time period made by a user through the directory or portal to the corresponding time period on the provider arrangement and to update the available time periods on the provider system and the user directory or portal to indicate that this time period is booked.

The method may include having the resource/service provider select a portal or directory in which to indicate available time periods within which they are able to provide a resource to a user. The method may be implemented using the system defined in any of the preceding aspects of the invention above.

The system defined in this application may conveniently be referred to as ‘Portal Synchronization Technology’. It allows the user of any Internet based scheduling booking system based on desktop, server, web, or mobile platforms, to list the same time slot across at least one of Internet based directories or portals, with synchronization taking place as bookings are completed on either the Internet based scheduling booking system or a participant Internet based directory or portal.

Time based businesses need better exposure on the internet and a way of attracting new business without being restricted to just one portal or business directory which may or may not be effective. In today's competitive business environment there is a commercial need for time-based businesses to maximise their exposure to attract new business. There is also an advantage to the public in having a plurality of competitive portals for facilitating searching and booking of time based appointments from an amalgamation of time-based professionals and resources online. There may also be advantages in handling emergencies as authorities could rapidly search for available medical service providers in a given area that are available.

To avoid double bookings it is important for each portal or business directory to be synchronised in real-time or some time increment with the scheduling booking system. It is also important for the users business to know from which portal the booking has come from. It is also important for existing third party portals to be able to participate in using this technology by way of access to “white label” versions of the technology and software, which they can rebrand or label as their own. The “white label” versions need to have the ability for the look and feel to be customised to suit the user's needs.

The present invention provides the advantage of being developed by way of programming new source code and producing software to enable a service/resource provider that is a business to be presented with a list of many business directories or portals from which they can select any number of portals or business directories to list their available time-slots on, for the public to book appointments or services.

According to another aspect of this invention there is provided a computer software code for integrating a provider of an online hosted scheduling booking system with at least one online directory or portal which is accessed by a user, wherein the code allows a user to select a time period from available time slots for that provider on the online directory or portal and make a booking on the portal which is then communicated to the provider.

According to another aspect of this invention there is provided a software program implementing the software code defined in the preceding aspect of the invention for carrying out the method for booking an appointment for a time period for utilisation of a time based resource defined in the second aspect of the invention above.

According to yet another aspect of the invention there is provided a computer program product for implementing a portal synchronization technology, the computer program product comprising a World Wide Web based scheduling booking system operating on a communications platform and a user system which communicates with the portal synchronization technology on the World Wide Web to allow the user to select a time-slot of available appointments or services, the time-slots being made available across at least one Internet based directory or portal which are capable of being selected to indicate a booking. A synchronization program is provided and used to synchronize both the portal synchronization technology and the at least one Internet based directory or portal as the time-slots are selected while simultaneously removing the time-slot from the available time-slots.

The user system may communicate with the portal synchronization technology to add or remove time-slots, to reschedule time-slots, to add or remove a recurring time-slot or to add or remove multiple time-slots.

The computer program product for implementing the portal synchronization technology system may use a 128/256 bit SSL encryption to protect the portal synchronization technology and the Internet based directories or portals.

According to a further aspect, the present invention provides a computer program comprising a source code to functionally implement a portal synchronization technology within an online hosted scheduling booking system, the computer program comprising a user system program allowing a user to login into their user system and communicate with the scheduling booking system to select at least one time-slot of available appointments or services as well as a program to automatically upload available time-slots to multiple public-facing fully integrated online business directories or portal web sites, the multiple public-facing fully integrated online business directories or portal web sites being selected by the user, allowing the user to select to add or remove time-slots from the multiple public-facing fully integrated online business directories or portal web sites from within the user system program.

The computer program may further comprise allowing third party online portals to integrate with the scheduling booking system to develop a computer program which is produced according to the present invention but may be labelled or branded as owned by the third party online portal.

The user system program may further provide for the user to continue to use their own scheduling program as a standard online scheduling booking system or any other licensed software. The system is able to make time-slots available or unavailable internally or make time-slots available or unavailable over the Internet from an Internet link or URL connected to the user system.

The computer program may facilitate a display of available time-slots by a user accessing their online scheduling booking system, selecting available time-slots and the directories or portals they wish the selected time-slots to be displayed on, and then causing the selected directories or portals to display the selected time-slots available for booking by other users or customers, e.g. substantially in real time.

The computer program may further comprise allowing a user to select time-slots not to be listed on the online business directories or portal web sites or to select some time-slots which are set to be available on a recurring basis on the online business directories or portal web sites.

Each online business directory or portal web site is automatically integrated with the computer program so that changing availability of time-slots within the system occurs in real-time as bookings of available time-slots are made either via the online business directories or portal web sites or if the user system program changes a time-slot.

The changes to the bookings of available time-slots may be automatically booked, removed or updated with the user system able to see which online business directories or portal web sites have changed the time-slot.

The online portals may be existing or new online Portals. For example, most business management systems with an inbuilt off-line appointment system can be integrated with the computer program for the portal synchronization technology to show tagged results of bookings coming in from the various portals or directories on which the user system is listed. The scheduling booking system of a service/resource provider will notify the scheduling booking system which portal delivered the booking. Further the scheduling booking system of a service/resource provider user system enables a provider to add or remove time slots that are currently available from a portal from within their scheduling booking system.

The portal synchronization technology may be used to include any related or unrelated existing or future portal offering persons, services or resources based on booking time slots within a day, and may be synchronised with the scheduling booking system to become part of the portal list for the user system to select from.

To receive the available appointments or services from each user system a number of online portals may be established to target specific industry types. Using the portal synchronization technology each portal may be integrated with user systems belonging to a user wishing to make time slots available for the booking of appointments or resources.

Existing portals may be invited to use the portal synchronization technology to allow their listings to become more diverse interactive so the businesses listed on their portals can take advantage of this greater diversity in available time periods to be booked.

### BRIEF DESCRIPTION OF THE DRAWINGS

The present invention will be understood more fully from the detailed description and drawings of an example embodiment of the present invention. The purpose of providing this detailed description is to describe to those skilled in the art how the present invention can be put into practice. The specific nature of this detailed description does not supersede the broad nature of the preceding summary of the invention. In the drawings:

FIG. 1 is a block diagram of a system for booking a time period in accordance with one example embodiment of the invention;

FIG. 2 is a flow chart showing the method implemented by the system shown in FIG. 1;

FIG. 3 illustrates one screen capture of one example of a system for booking a time period in accordance with the invention;

FIG. 4 illustrates a further screen capture of the example shown in FIG. 3;

FIG. 5 illustrates a screen capture of a search system for making online bookings;

FIG. 6 is a screen capture of a provider of time based service using the system of FIG. 1;

FIG. 7 is a screen capture of a list of available time periods available on a scheduling booking system of a service provider;

FIG. 8 is a screen capture of an allocation of the list of available time slots shown in FIG. 7 to different portals;

FIG. 9 is a screen capture showing the available time periods that have been allocated to a certain portal so that they can be displayed on that portal and be booked on that portal;

FIG. 10 is a screen capture of a portal having a portal search engine suitable for use with the system for booking of this invention;

FIG. 11 is a screen capture displaying the results of the search illustrated in FIG. 10 by the search engine illustrated in FIG. 10;

FIG. 12 is a screen capture displaying an appointment that has been booked by a user through the portal shown in FIG. 10;

FIG. 13 is a screen capture of a confirmation of the appointment booked by a user through the portal shown in FIG. 10;

FIG. 14 is a screen capture of a display on the interface of the service provider providing confirmation of the booking of the time period on the portal of FIG. 10;

FIG. 15 is a screen capture of a directory service search engine in accordance with the present invention; and

FIG. 16 is a screen capture of the results screen output from the search carried out in FIG. 15.

### DETAILED DESCRIPTION OF THE PREFERRED EMBODIMENTS

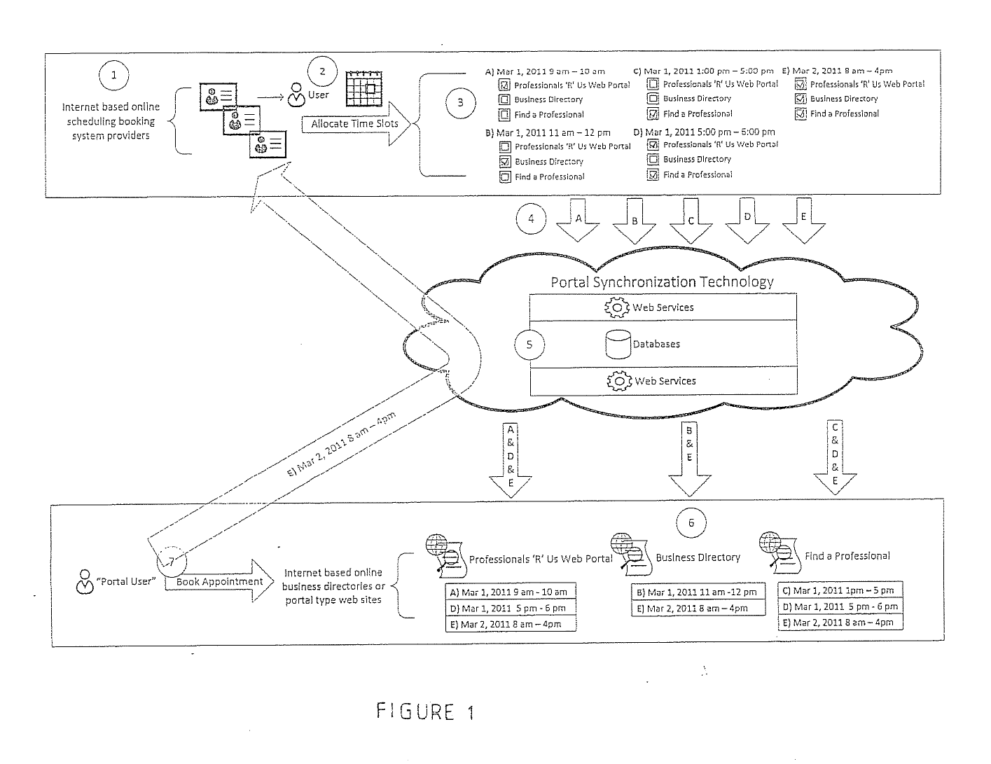

FIG. 1 shows a block diagram of a system for booking a time period for utilising a time based resource or service provided by a resource/service provider in accordance with one embodiment of the invention.

The system includes a provider arrangement on which at least one resource/service provider can indicate available time periods within which they are able to provide a resource or service to a user. The system also includes at least one user directory or portal which indicates time periods of the service or resource provider/s that are available to be booked by a user, and which facilitates booking of one or more of the available time periods by a user through the directory or portal. The directory or portal has a user interface that enables a user to access and view the available time periods of the service/resource provider and make a booking.

The system also includes a synchronization and communications arrangement (synchronization arrangement), which communicates with the user directory or portal and also with the provider arrangement over a communication network that is the world wide web. When a time period made available by a user through a directory or portal is booked the synchronization arrangement updates the available time periods on the provider arrangement and the user directory or portal to indicate that this time period is booked. The synchronization arrangement further sends a message to the service/resource provider to advise it that the time period has been selected. It further indicates to the service/resource provider which portal or directory has been used by the user to make the booking.

Further the service/resource provider can communicate with the synchronization and communications system to cancel certain time periods that they have been previously indicated as being available time slots. The synchronization arrangement causes these cancelled time periods to be removed from the portal or directory so that they are no longer displayed as available time slots.

In computing generally, browser applications typically include simple office software (such as word processors, online spread sheets, and presentation tools), and can also include more advanced applications such as project management, computer-aided design, video editing and point-of-sale applications. These applications have become widely used tools for accessing the vast amounts of information that are available via computer networks, such as the World Wide Web via the Internet or on mobile communication devices. At its basic level of operation, the browser permits a user to connect to a given network site, and download informational content from that site, such as an HTML document, for display at the user's computer. To view additional information, or a different type of information, the user designates a new network address, e.g. a different HTML file, whose contents then replace the previously displayed information on the user's computer.

An Internet Portal is defined as a system that provides an entry point or gateway that provides users with an easy, intuitive, customizable interface to access a wide pool of information. It thus alleviates the need to navigate from one network site to another to access and view different content. The information of the portal is obtained from multiple sources and is typically catalogued and organised on the portal according to the needs and interests of users accessing the portal. With a portal the information is stored at a plurality of different network addresses, including different sites, and the portal enables all this information to be accessed through one site namely the portal site. Many companies and organizations provide different types of portals for a variety of purposes, including portals for the general public, intranet portals for their employees, and extranet portals for their customers, vendors, suppliers and other parties with whom they transact business.

In use a service provider has an Internet based scheduling booking system on their communications platform that interfaces with the system in accordance with this invention. The service provider has the ability to allocate their available time to several Internet based directories or portals as shown at reference numeral 2. In this example the service provider is utilising three Internet based directories or portals. However it will be appreciate that this is just one example and any number of Internet based directories or portals can be utilised by the service provider.

As shown at reference numeral 3 the service provider has chosen to allocate and publish at reference numeral 3 their available time amongst three Internet based directories or portals. The time periods available to be booked are not the same for each service provider. The service provider has made different permutations or combinations of their available time periods available on each of the portals. These permutations are described (as examples only) below:

A) For Mar. 1, 2011 from 9 am to 10 am, the user has chosen to allocate and publish their available time only to the “Professionals ‘R’ Us Web Portal” Portal;

B) For Mar. 1, 2011 from 11 am to 12 pm, the user has chosen to allocate and publish their available time only to the “Business Directory” Portal;

C) For Mar. 1, 2011 from 1 pm to 5 pm, the user has chosen to allocate and publish their available time only to the “Find a Professional” Portal;

D) For Mar. 1, 2011 from 5 pm to 6 pm, the user has chosen to allocate and publish their available time to both the “Professionals ‘R’ Us Web Portal” and “Find a Professional” Portals; and

E) For Mar. 2, 2011 from 8 am to 4 pm, the user has chosen to allocate and publish their available time to all three portal, namely “Professionals ‘R’ Us Web Portal”, “Find a Professional”, and “Business Directory”.

The system for booking a time period according to the present invention allocates at reference numeral 4 the selected available times to the different portals and publishes the selected available times on the portal. It does this using custom web services on the Internet. The system as shown at reference numeral 5, includes a custom web service code and databases which receive the time allocation from the user and publishes it to each respective Internet based online business directory or portal type web site. Each of the Internet based directories or portals is also interfaced with the system and particularly the communication arrangement and as shown at reference numeral 6, subscribes to the system to display the respective times of the user that have been allocated.

When a user of one of the “Internet based directories or portals” selects an available time slot, the available time slot is then booked as shown at reference numeral 7 by the hosting Internet based directory or portal, and the appointment is reserved on the originating Internet based scheduling booking system. On the Internet based scheduling booking system the time-slot status for that particular time period changes from ‘available’ and instead displays details of the booking. The previously ‘available’ time slot which has now been booked is removed in real time, e.g. substantially simultaneously, from each Internet based directory or portal displaying the allocated listing.

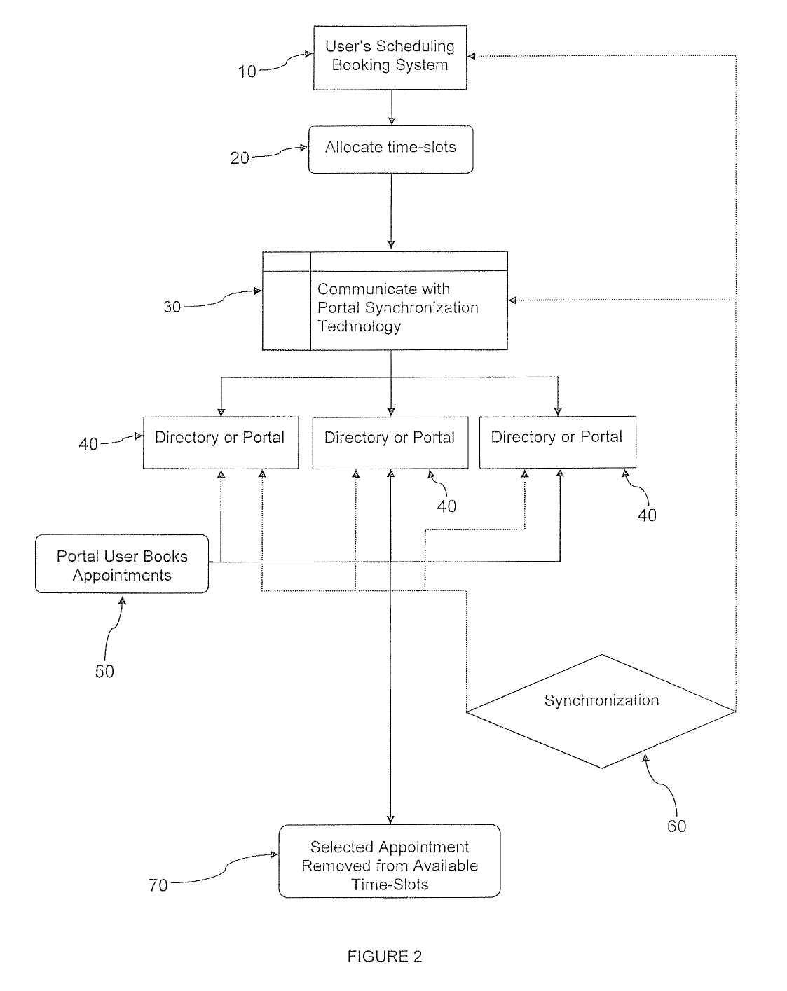

FIG. 2 shows a flow chart of a method that is carried out by a system for booking time in accordance with the present invention. The service provider or user has an Internet based scheduling booking system 10 on their communications platform that is operatively connected to the system and in particular the communications arrangement. A service provider user using their scheduling booking system 10 have the ability to allocate their available time-slots 20 to several Internet based directories or portals 40.

The system may be provided to a customer in the form of a custom web service code and databases. When executed this code receives the time-slot 20 allocations from the provider and publishes it to each selected Internet based online business directory or portal type web site 40.

A portal or web portal 40, also known as a links page presents information from diverse sources in a unified way. Apart from a standard search engine feature, web portals may offer other services such as e-mail, news, stock prices, information, databases and entertainment. Portals provide a way for enterprises to provide a consistent look and feel with access control and procedures for multiple applications and databases, which otherwise would have been different entities altogether. An online directory is simply a way of keeping information about files. For example, the yellow pages directory is an electronic directory, which contains multiple folders in file cabinets that contains folders that contain files of information about phone numbers and businesses.

A portal user 50 will select or book a time-slot or time period for receiving an appointment or service through one of the online directories or portals 40. A time-slot is simply a time assigned on a schedule or agenda. For example, a time period from 9.00am to 10.00am has a defined time slot which runs for a definite length of time marked off by two instants namely a first or start instance and a second or finish instance.

The directories and portals 40, and the provider's scheduled booking system 10 are synchronized 60. By this is meant that they are updated in real time by means of the communications arrangement so that any bookings are automatically reflected and updated across the system. This ensures that there are no double bookings when a time slot is booked and that the time slot is removed from the other portals.

The synchronization and communications arrangement has synchronization software 60 that prevents double bookings by synchronizing the directory or portal 40 and the provider's scheduling booking system 10. When a time-slot is booked it is substantially simultaneously removed 70 from the directory or portal 4,0 and a confirmation of the booked appointment as well as which directory or portal 40 at which the booking has been made is sent to the provider's scheduled booking system 10.

Conveniently, the confirmation which is sent to the provider's scheduled booking system 10 is in the form of an electronic message such as an email or a short message service (SMS), or a text communication service. The electronic message is sent via a wireless network to a mobile or fixed line communication device, such as telephones using standardized communications protocols or the message can be sent via the web using standardized communications protocols know known or later developed.

The system can be provided to customers in the form of computer software with source code functionality for the implementation of the system. The system can be integrated within an online hosted scheduling booking system which allows a service provider to log in to their scheduling booking system 10 and select time slots 20 for available appointments or services to be automatically uploaded onto certain public-facing directories or fully integrated Portal web sites 40. A user or provider of a business can add time-slots to directories or portals 40 or remove time-slots from directories or portals 40, through their online scheduling system. This may also include adding or removing a recurring time-slot or adding or removing multiple time-slots.

The online directories or portals 40 may be either existing new online directories or portals 40 or new online directories or portals 40. Most business management systems with an off-line appointment system can be integrated with the system to show tagged results of bookings 50 resulting from the various directories or portals 40 on which the business is listed. This enables the provider business to see which directory or portal 40 has delivered the booking.

With this system, any related or unrelated existing or future directory or portal 40 offering time-slots for booking, can be synchronised with the system for booking time slots to increase the reach or exposure of the available time slots.

A number of online directories or portals 40 with different user characteristics can be established to receive the ‘available time listings’ from each business or provider. In addition existing directories or portals 40 can be invited to use the system to expand their listings. The additional time slots offered on the existing directories or portals can increase the traffic in bookings on the existing directories or portals 40 thereby to make them more productive and profitable. This way the system can be useful for both existing portals as well as service providers.

The following list shows an example list or selection of online directories or portals 40 (with time-based businesses) which may be established using this system:

Business Portal;

Accountants Portal;

Lawyers Portal;

Beauty Care Portal;

Wellness Portal;

Meeting Room Portal;

Sporting Facilities Portal;

Equipment Hire Portal;

Medical Portal; and

Health Care Portal.

Using this system the online directories or portals 40 integrated with the system will provide a valuable service whereby users (customers in the general public) will be able to search for specific listed services, in a given location. The customer will then be able to book a time-slot to make an appointment with a service provider or book a time-based resource or service in real-time with instant confirmation.

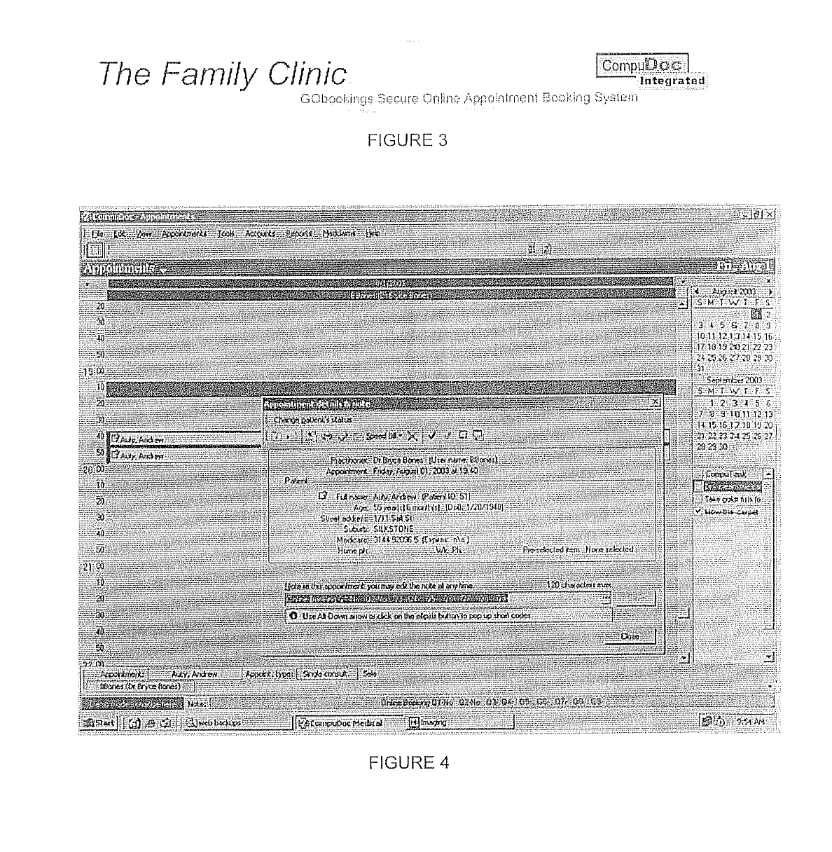

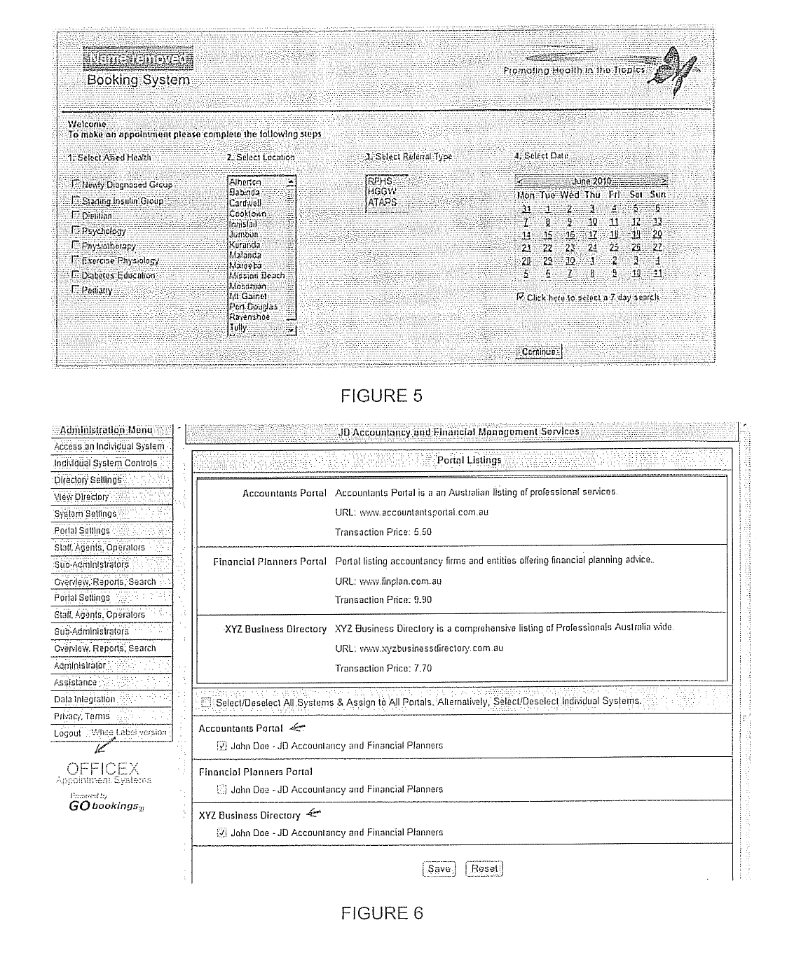

FIGS. 3 to 5 shows screen captures of one example of a time based system in accordance with one embodiment of the invention using a portal. The time based system is for advertising available appointment times at a family clinic across a plurality of portals.

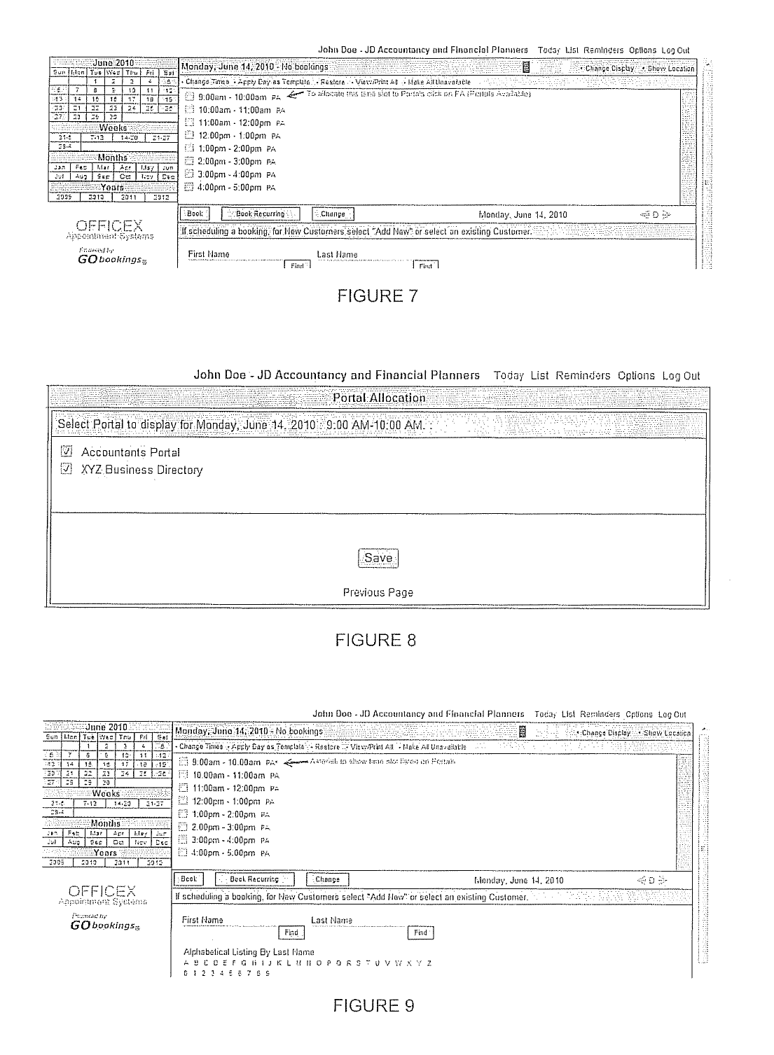

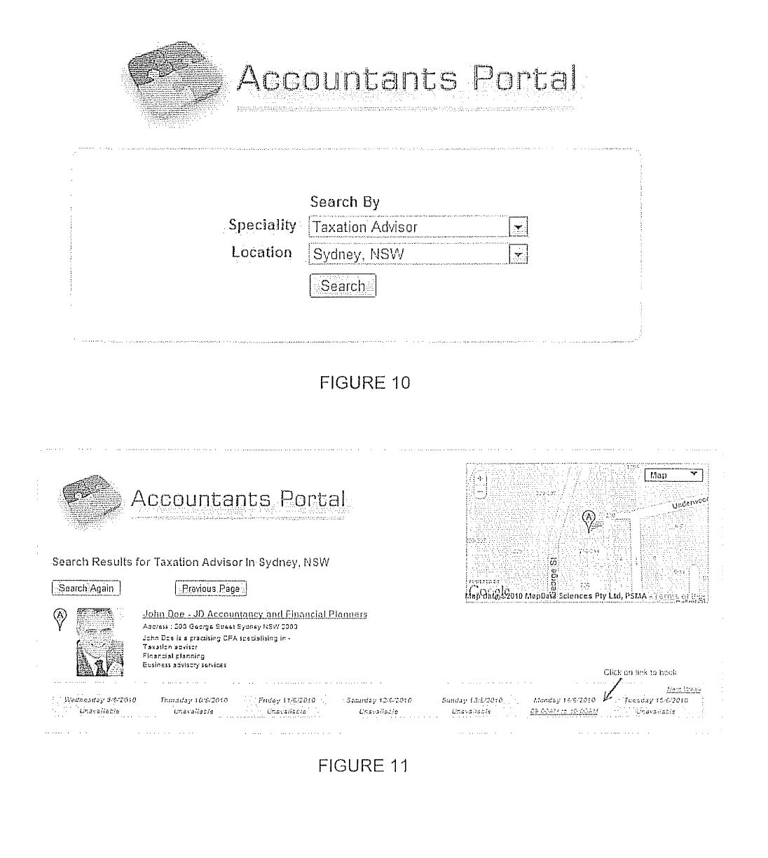

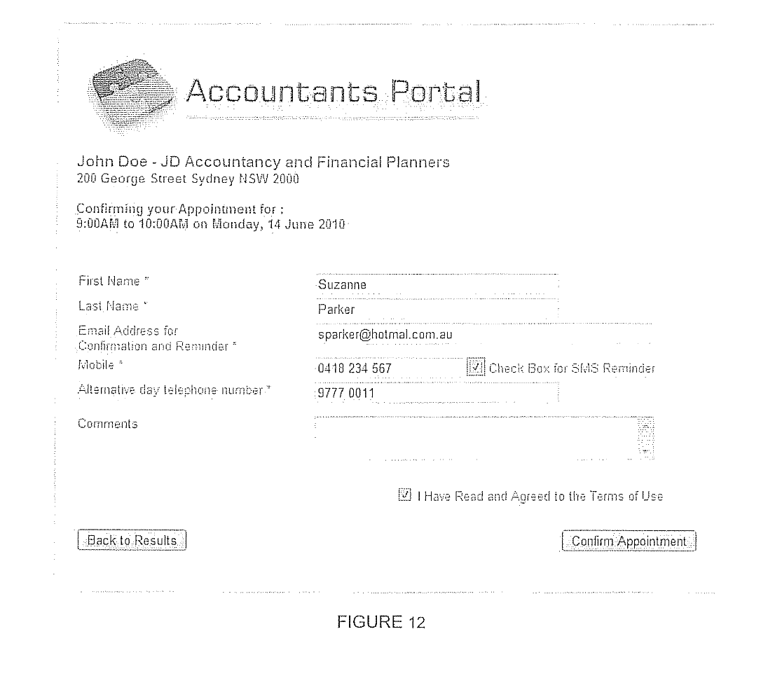

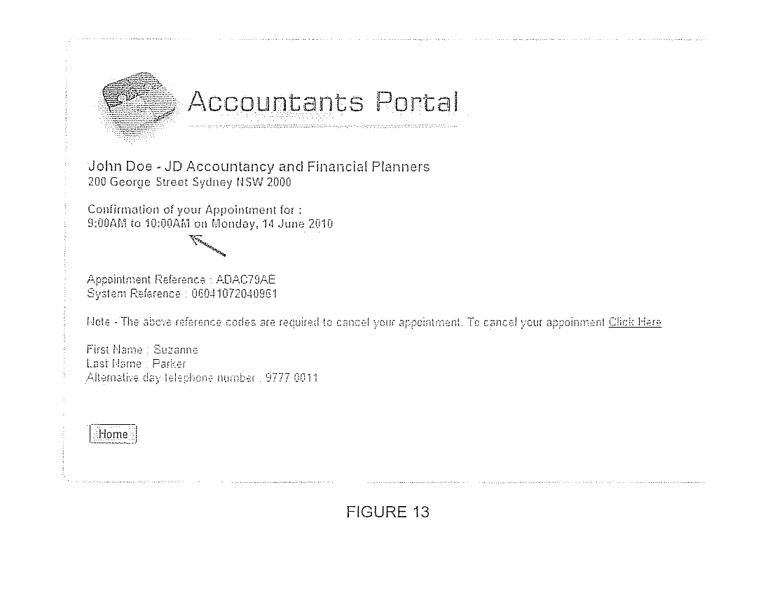

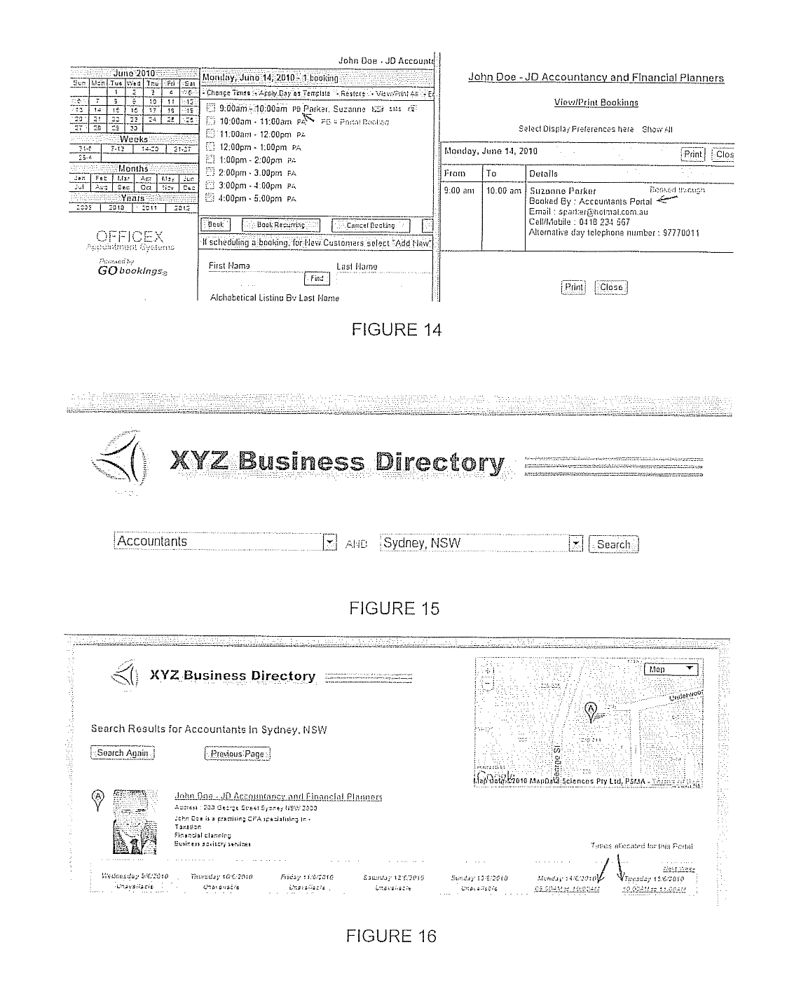

FIGS. 6 to 14 show screen captures of an example of a time based system in accordance with another embodiment of the invention using a portal. The time based system shows an accountancy and financial management services business advertising available time slots on an accountancy portal. FIGS. 15 and 16 show screen captures of the accountancy business advertising available time slots on a directory that is an XYZ business directory portal.

This system will now be described in some detail with reference to the drawings above. The accountancy business which uses the system may decide to list time-slots for appointments on two directories or portals namely, The Accountants Portal and the XYZ Business Directory.

The accountancy business has time-slots that are available for booking online, through their online scheduling booking system by the public accessing their website on the internet and not through a portal. These time slots do not appear on the online directories or portals 40 and this enables the business to selectively vary the time slots that are available to be booked through the various gateways.

The system can continue to be deployed as a standard online scheduling booking system 10 able to take bookings over the internet from an internet link or uniform resource locator (URL) that specifies where an identified resource is available and the mechanism for retrieving it is connected to the system operated by the business 10. Further the business does have the option of making available, time-slots on their system 10, for automatic and instant listing in real-time by selecting directories or portals 40 listed within their system 10.

Each online directory or portal 40 allows any number of competing businesses with systems 10 to display their available times to attract new customers. The process for a business to display their available time slots on the portals 40 is simple. All they need to do is enter the system 10 through their log in and select the directories or portals 40 on which they wish selected available time slots to be advertised.

Each selected online directory or portal 40 automatically integrates with the scheduling booking system of the provider and changes availability within their scheduling booking system in real-time as bookings are made via the selected directories or portals 40. In this application real-time is taken to mean responding to bookings within a predictable time after their occurrence. For example, the changing of bookings will typically occur at a time period dependent upon the polling time of the portal or directory 40, which is set by the system or is agreed up on by the users of the system.

Once a time-slot 20 is booked 50 then it is automatically removed from all directories or portals 40 and appears instantly on the scheduling booking system of the provider or business with whom the booking is made. It also indicates salient details of the booking. This rapid synchronization resists the chance of duplicate bookings by the system.

The provider of the system provider and/or each directory or portal 40 may charge the customer and/or the business (provider) a booking fee for the service. This enables a competitive environment to develop between directories and portals 40 where they compete for listings and for the customers to make bookings. To protect the security of data 128/256 bit SSL encryption is used throughout the system. Secure Sockets Layer (SSL) is a cryptographic protocol that provides communications security over the Internet.

One of the advantages provided for providers or businesses by the system 30 is that the online directories or portals 40 are capable of delivering new business at times selected by the business without affecting or impacting on times made available for existing customers of the business accessing available time periods through previously existing channels. The instant a booking is made the business simultaneously receives an email confirmation with an optional SMS confirmation. Details of the booking automatically appear instantly in their system 10 and the available time-slot is simultaneously removed from the directory or portal 40.

An advantage of this system for the customer is that the online directories or portals 40 provide a quick and easy way of searching for, locating and booking a service in real time across a number of competing businesses in a given location with instant confirmation and reminder email and optional reminder SMS text message.

A system for enabling synchronization between internet based scheduling booking systems 10 and Internet based directories or portals 40 facilitates the allocation of one or many available times from within their Internet based scheduling booking system 10 to one or many Internet based directories or portals 40. These include:

(a) Internet based scheduling booking systems 10, utilising the portal synchronization technology services 30;

(b) Internet based directories or portals 40, utilising the portal synchronization technology services 30; and

(c) An intermediary server operable to connect to server data to both the Internet based scheduling booking systems 10 and Internet based directories or portals 40, and a database.

The system provides a publishing facility that enables a provider of an Internet based scheduling booking system 10 to:

(a) selectively determine and allocate one or many available time-slots 20 from within their Internet based scheduling booking system 10 to one or many Internet based directories or portals 40; and

(b) a query facility to allow the retrieval of confirmed (booked), reserved, or cancelled appointments, services, or resources.

The system provides a subscription facility that is operable to enable an Internet based directory or portal 40 to:

(a) publish the Internet based scheduling booking system's appointments, services, and resources; and

(b) a confirm (book), reserve, or cancel facilities to schedule the appropriate appointments, services, and resources accordingly.

The system allows a service provider having an Internet based scheduling booking system based on desktop, server, web, or mobile platforms, to list the same time slot across one, or a plurality of Internet based directories or portals, with synchronization taking place as bookings are completed on either the Internet based scheduling booking system or a participant Internet based directory or portal.

The technology in accordance with this invention comprises an intermediary system, computer program, and method for enabling the synchronization between Internet based scheduling booking systems (systems) and Internet based directories or portals (portals) facilitating the allocation of one or many available times from within a user's Internet based scheduling booking system to one or many Internet based directories or portals.

The system for booking a time period which is conveniently described as ‘Portal Synchronization Technology’ includes innovative web service applications and server databases. It provides a publish facility that is operable to enable a user of an Internet based scheduling booking system to: selectively determine and allocate one or many available times from within their Internet based scheduling booking system to one or many Internet based directories or portals; and a query facility to allow the retrieval of confirmed (booked), reserved, or cancelled appointments, services, and resources. For example, an appointment may be with a person, such as an insulation installer or an electrician, whereas a resource may be an item of equipment or a tennis court. The portal synchronization technology also provides a subscribe facility that is operable to enable an Internet based directory or portal to publish Internet based scheduling booking system appointments.

In one example the Internet based scheduling booking systems will poll the portal synchronization technology web services applications to synchronise the schedules of the latest appointments, services, or resources from the Internet based directories or portals, such as bookings, and cancellations, new time slots, rescheduled time slots, recurring timeslots (eg every Monday), multiple bookings, group bookings and general booking related information. In another example the providers of Internet based scheduling booking system will utilise the portal synchronization technology web service applications to allow their clients to list one or many available times from within their Internet based scheduling booking system to one or many Internet based directories or portals.

In yet another example the Internet based directories or portals will poll the portal synchronization technology web services applications to publish/display the Internet based scheduling booking system appointments, services or resources;

In a further example the Internet based directories or portals will utilise the portal synchronization technology web service applications by posting information to confirm (book), reserve, or cancel facilities to schedule the appropriate appointments, services, and resources accordingly.

Although the present invention has been illustrated and described with respect to exemplary embodiment thereof, it should be understood by those skilled in the art that the foregoing and various other changes, omissions and additions may be made therein and thereto, without departing from the scope of the present invention.

In the claims:

1. A system for booking a time period for utilising a time based resource or service provided by a resource/service provider, including:
at least one provider arrangement on which a resource/service provider can indicate one or more available time periods within which they are able to provide a resource or service to a user;
a plurality of user directories or portals, each of which indicates said time periods of the service or resource provider/s that are available to be booked on that directory or portal by a user, and which facilitates booking of one or more of the available time periods by a user on a said directory or portal through the directory or portal; and
a synchronization and communications arrangement, which facilitates direct communication between the provider arrangement and each user directory or portal over a communication network, whereby to communicate the booking of an available time period on a said directory or portal by a user to the provider arrangement and the other directories or portals, whereby to update the available time periods on the provider arrangement and the user directories or portals and to remove each time period that has been booked from the available time periods.

2. The system of claim 1, including a plurality of provider arrangements, each of which provides a different provider with access to the booking system.

3. The system of claim 1, wherein each provider arrangement enables a resource/service provider to select which time periods are available to be booked on each of the user directories or portals, and wherein the synchronization and communications arrangement communicates the time periods that are available to be booked on each directory or portal to that directory or portal and not to the other directories or portals.

4. The system of claim 1, wherein said synchronization and communications arrangement enables the provider arrangement/s to communicate directly with each user directory or portal on which time periods are available to be booked whereby to update the provider arrangement/s and each of the directories or portals in real time.

5. The system of claim 1, wherein each provider arrangement enables the associated provider to alter any one of the time periods that are available to be booked on said plurality of user directories and portals, and wherein said synchronization and communications arrangement facilitates direct and continuous communication between the provider arrangement and each user directory or portal whereby to update the available time periods on the relevant user directories and portals to reflect these alterations in the user directories and portals.
